(19) United States
(12) Patent Application Publication
(10) Pub. No.: US 2018/0015705 A1
(43) Pub. Date: Jan. 18, 2018

(54) STRUCTURAL COMPONENT FORMING AN ELECTRICAL POWER SOURCE, STRUCTURAL COMPONENT WITH AN ELECTRICAL TRANSMISSION DEVICE, METHOD FOR PROVIDING A STRUCTURAL COMPONENT FORMING AN ELECTRICAL POWER SOURCE AND/OR AN ELECTRICAL TRANSMISSION DEVICE, ELECTRICAL WIRING SYSTEM AND AIRCRAFT COMPONENT

(71) Applicant: AIRBUS OPERATIONS GMBH, Hamburg (DE)

(72) Inventors: Peter LINDE, Hamburg (DE); Leif ASP, Moelndal (SE); Dan ZENKERT, Lidingö (SE)

(21) Appl. No.: 15/651,614

(22) Filed: Jul. 17, 2017

(30) Foreign Application Priority Data
Jul. 18, 2016 (EP) 16 180 005.7

(51) Int. Cl. B32B 27/12; B32B 5/26; C08J 5/24; D06M 11/83

(52) U.S. Cl. CPC B32B 27/12; D06M 11/83; B32B 5/26; C08J 5/24

(57) ABSTRACT

A structural component includes a composite laminate built up of layers of carbon fibers, wherein the layers of carbon fibers are oriented in different directions and wherein the carbon fibers are surrounded by a conductive polymer resin. The carbon fibers of at least one of the layers include an electrically insulating coating, and wherein at least one of the coated carbon fibers extend through its respective layer to form an electrical connection between ends of the layer spaced apart from one another. With an ion-transmissive insulation coating the carbon fibers form anodes such that, together with a metal layer provided with the composite laminate forming an cathode, the structural is enabled to additionally form an integrated composite power source.

### TECHNICAL FIELD

The present disclosure pertains to a structural component forming a power source, a structural component with an electrical transmission device, a method for providing a structural component forming a power source and/or a structural component with an electrical transmission device, an electrical wiring system, and an aircraft component.

Although applicable for any kind of vehicle, the present disclosure and the corresponding underlying problems will be explained in further detail in conjunction with an aircraft component.

### BACKGROUND

Present electrical wiring systems of aircrafts usually comprise a plurality of electrical wires in the form of single cables which are combined in a duct being coupled to a fuselage structure of the aircraft. These wiring systems are used for transmission of electrical power or data transmission. Accordingly, the aircraft data-transmission system is built up essentially of electrical wires that are placed separated from the cabin panels. These wires run in cable bundles, often jointly with power cables. Typically, each wire is solid and round and is supplied with insulation. Several such wires run together in cable bundles. Again, these bundles are fixed into their locations by brackets. The brackets are attached to cabin panels.

### SUMMARY

It is an idea of the disclosure herein to provide a structural component, in particular structural component for an aircraft, forming a power source and/or with an electrical transmission device and an electrical wiring system which comprise a light weight structure and which can be installed in an easy and flexible manner, respectively.

According to a first aspect of the disclosure herein, a structural component comprises a composite laminate built up of a plurality of layers of carbon fibers, wherein the layers of carbon fibers are oriented in different directions, wherein the carbon fibers are surrounded by a conductive polymer resin, and wherein at least one layer of carbon fibers forms an anode. The structural component further comprises a metal mesh doped with an active cathode material forming a cathode with a flat profile, an ion-transmissive, electrically insulating separator arranged between the anode and the cathode, whereby the composite laminate forming a power source according to the type of a battery device.

Progress made in the field of battery technology can be integrated with a structural component, that is, provided a cathode is present, using the carbon fibers as anodes, electrical power can be provided, inherent in the composite itself, while no separate electrical power cables are needed. The basis for the disclosure herein is a composite laminate of the structural component which is built up of several layers (“plies”) of carbon fibers. The plies are oriented in different directions. The fibers are surrounded by polymer resin. This laminate has structural capabilities. Further, there are modifications made to an ordinary composite laminate. Apart from a layer of carbon fibers, which constitute anodes, and the polymer resin there exists a metal layer, doped with an active cathode material, serving as cathode, and an insulating layer, serving as a separator. Providing the separator is ion-transmissive, all the elements needed for a functioning power source according to the type of a battery are present.

According to one embodiment of the structural component the active cathode material is an electrolyte material, especially a LiMn₂O₂, a LiCoO₂ or a LiFePO₄ material. The latter of these materials provides a high security level, high power density, high peak power, high charging current, high cycle stability, high electrical efficiency and a flat voltage profile while charging and uncharging when used as a cathode material for a power source.

According to another embodiment of the structural component, the ion-transmissive separator is a glass fiber layer arranged between the at least one carbon layer forming the anode an the metal mesh, whereby the anodes are effectively separated and electrically insulated from the cathode, while the ion transmission is ensured.

In another embodiment of the structural component at least the carbon fibers of the at least one carbon layer forming the anode are set up with an ion-transmissive, electrically insulating coating forming the separator, whereby the arrangement of a separate layer, e.g. a glass fiber layer, between the anodes formed by the carbon fibers and the cathode formed by the metal layer can be omitted.

In another embodiment, the structural component may be adapted such, that the doped metal layer is set up by a metal mesh, for example a mesh made of copper, whereby the metal layer obtains a light weight structure with a flat profile which is easy to integrate in the composite laminate.

According to a second aspect of the disclosure herein, a structural component comprises a composite laminate built up of a plurality of layers of carbon fibers, wherein the layers of carbon fibers are oriented in different directions and wherein the carbon fibers are surrounded by a conductive polymer resin, wherein the carbon fibers of at least one of the layers comprise an electrically insulating coating, and wherein at least one of the coated carbon fibers extend through its respective layer to form an electrical connection between ends of the layer spaced apart from one another.

Providing the structural component with coated carbon fibers provides a structural device with a functionality as an electrical transmitter, for example an electrical data transmission cable, which itself constitutes an integral part of the composite laminate while the structural component continues to maintain its original function, which is to carry a load. In other words, this constitutes some sort of a multifunctional cable.

In another embodiment of the structural component, the electrically insulating coating of the carbon fibers is ion-transmissive.

According to one embodiment of the structural component stripped end portions of the at least one coated fiber protrude from its respective end of the layer easing the connection with at least one transmission apparatus, or transmitter, or its subset. For example, the transmission apparatus is formed by at least one electrical circuit, which is connectable to at least one power source and/or at least one signal processing device.

The use of a plurality of coated carbon fibers provided for electrical transmission provides redundancy.

Further, these coated carbon fibers can have very small diameters, which is in the order of some microns, for example between 3 and 12 micrometers, or between 5 and 10 micrometers, because the cross section of an ordinary metallic signal cable is reduced drastically. In addition, a rubberized insulation is not used here, nor are the brackets to fasten cables.

A third aspect of the disclosure herein relates to a structural component wherein a composite laminate built up of a plurality of layers of carbon fibers forms a power source to drive electrical signals over at least one electrical connection formed by at least one coated carbon fiber extending through its layer between ends of the layer spaced apart from one another. According to this aspect, the simultaneous integration of a signal transmission capability with the electrical power function provided by a power source constituted by a composite battery is established, as both can be obtained from the same composite laminate. Accordingly, the structural component provides its structural function as well as data transmission and an electrical power source.

A fourth aspect of the disclosure herein relates to a method for providing a structural component, in particular a structural component according the preceding explanations comprising at least the providing of a composite laminate of carbon fiber layers with at least one of which layers containing carbon fibers coated with an electrically insulating coating, the manufacture of the structural component, the stripping of the insulation at opposite ends of at least one coated carbon fiber, connecting the stripped ends of the at least one carbon fiber with a signal processor and/or a power source, transmitting signals or power.

The manufacture of the structural component is eased by a variant of the method, wherein the at least one coated carbon fiber is provided as a carbon fiber yarn or tow coated with an electrically insulating polymer electrolyte.

Another variant of the method provides the use of digital data transmission, which may pass through several cables, whereby the data signals are coded as to which is the sender and for which receiver they are determined. In this manner an electrical redundancy can easily be achieved, if a damage occurs at one location. This redundancy is not necessarily given for today's common single metallic cables.

A further aspect of the disclosure herein relates to an electrical wiring system, extending along a structural component of an aircraft, wherein the electrical wires are formed by coated carbon fibers extending through at least one layer of a composite laminate of the structural component thereby providing a possibility to transport electrical signals along the structural component with little installation effort.

A fourth aspect of the disclosure herein concerns an aircraft, comprising a structural component with the composite laminate comprising a coated carbon fiber layer according to one of the embodiments described above. In particular, the structural component described above comprises a low weight per length due to the integration the electrical wiring in the component. Hence, the structural component may a be integrated in an aircraft, i.e. as a data transmission line or an electrical supply line for electrical functional components arranged within the interior of a fuselage structure of an aircraft, i.e. lighting devices, pumps, or such like.

Generally, according to the present disclosure the structural component and its operating method provide the possibilities, that neither a separate manufacturing of electrical circuitry nor a separate installation of cable bundles is necessary, brackets to fasten cables can as well be avoided as any bonded power/data transmitting tapes or any ink-jet printed circuits. Additionally, no foreign objects are inserted into the sensitive laminate, such as copper cables, fiber optical cables etc., that may deteriorate the structural performance and can be cause for delaminations and cracks. Space requirements as well as weight are reduced, there exists a lower risk that cables or jet-ink circuits are torn apart or damaged during work and maintenance. Further, there is no risk of vibrating cables, and the efforts for inspection and maintenance are reduced significantly. If using digital data transmission with a plurality of fibers, a redundancy is achieved, not available for single metallic cables, which constitutes an safety-improvement.

By integration with a composite power source separate power sources for signals are made unnecessary, while at the same time weight and space are saved and a lowered transmission loss occurs. This holds for a separate power source for steering signal devices made unnecessary as well as additional power cables as power is provided everywhere by integration with a composite power source. Finally there also exists the possibility to connect an arbitrary number of composite power source panels or cells for a tailored amount of voltage.

### BRIEF DESCRIPTION OF THE DRAWINGS

The disclosure herein will be explained in greater detail with reference to example embodiments depicted in the drawings as appended.

The accompanying drawings are included to provide a further understanding of the present disclosure and are incorporated in and constitute a part of this specification. The drawings illustrate the embodiments of the present disclosure and together with the description serve to explain the principles of the disclosure herein. Other embodiments of the present disclosure and many of the intended advantages of the present disclosure will be readily appreciated as they become better understood by reference to the following detailed description. The elements of the drawings are not necessarily to scale relative to each other. Like reference numerals designate corresponding similar parts.

FIG. 1 schematically illustrates a well known structural component represented by a composite laminate panel built up from layers of carbon fibers;

FIG. 2 shows the embodiment of FIG. 1 in greater detail as to observe single carbon fibers in a sectional view of a carbon fiber layer;

FIG. 3 schematically illustrates an exemplary embodiment of a structural component according to the disclosure herein with a single layer of adjacent carbon fibers provided with a coating in a sectional view;

FIG. 4 shows the embodiment of FIG. 3 with one coated carbon fiber with a stripped end portion;

FIG. 5 schematically illustrates a further exemplary embodiment of a structural component according to the disclosure herein with a composite laminate panel with coated fibers with one coated fiber protruding at opposite ends of a single layer;

FIG. 6 shows the embodiment of FIG. 6 in greater detail with one of the protruding ends of the fiber with a stripped end portion;

FIG. 7 schematically illustrates an exemplary embodiment of a structural component according to the disclosure herein with the composite laminate comprising carbon fibers serving as anodes, and a metal layer doped with an active cathode material serving as cathode, and one glass fiber layer serving as a separator between anodes and cathode;

FIG. 8 schematically illustrates the integrated function of an exemplary embodiment of a structural component integrated signal transmission and composite power source.

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

### DETAILED DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

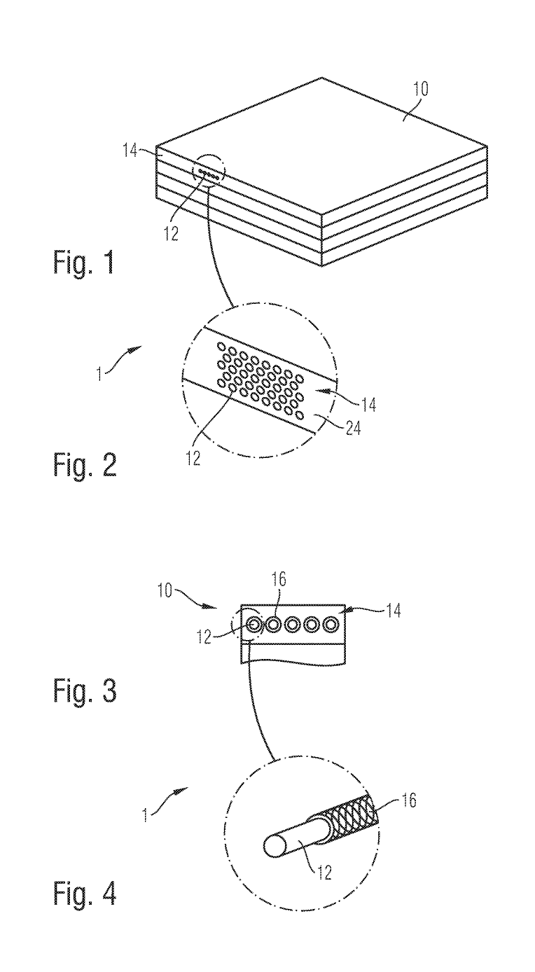

FIGS. 1 and 2 show a structural element 1 as known in the art. FIG. 1 in particular shows a structural element 1 formed by a composite laminate 10 as seen in a sectional view built up of several layers of carbon fibers 12, also referred to as “plies”. The plies are oriented in different directions. The fibers 12 are surrounded by polymer resin 14. This composite laminate 10 as part of a structural element 1 has structural capabilities and is able to carry a load not shown here.

FIG. 3 shows a structural element 1 according to the disclosure herein. Here, fiber coatings 16 surrounding the carbon fibers 12 provide an electrical insulation. Thus, for example, these coatings 16 can take over the insulating function of an insulation layer of the composite laminate 10 not shown here. This can result in a significant reduction of laminate thickness and by that provide a reduced weight and thinner thickness. Furthermore, the fiber coatings 16 are ion-transmissive to provide the capability to form a power source device 30 from the composite laminate 10, wherein the coated fibers 12 form a plurality of anodes 36.

FIG. 4 shows the embodiment of FIG. 3 in greater detail with one coated carbon fiber 13 with a stripped end portion 22. Inside one can see graphitic carbon, with good electrical conduction properties, and on the outside is the electrically insulating coating 16. Thus, we now have a structural device with functionality as an electrical transmitting cable, e.g. a data transmitting cable, the cable being considerably smaller in diameter, in the order of some micrometer. Accordingly, figuratively spoken, the coated fibers 12 built an electrically charged “cable” extending through the structural component 1, which itself is additionally provided with electrically conducting capabilities and therefore is able to transport power or data in form of signals along its extension.

As best can be taken from FIG. 5, is the manner how to connect the “cable” formed by the coated carbon fiber 13 to an external source. FIG. 5 schematically illustrates an exemplary embodiment of the structural element 1 with a composite laminate panel 10 with coated fibers 12 with one single coated fiber 13 protruding at opposite short ends 26 of a single layer 24 of the composite laminate panel 10. The coating 16 of the fibers 12 is provided ion-transmissive and electrically insulating.

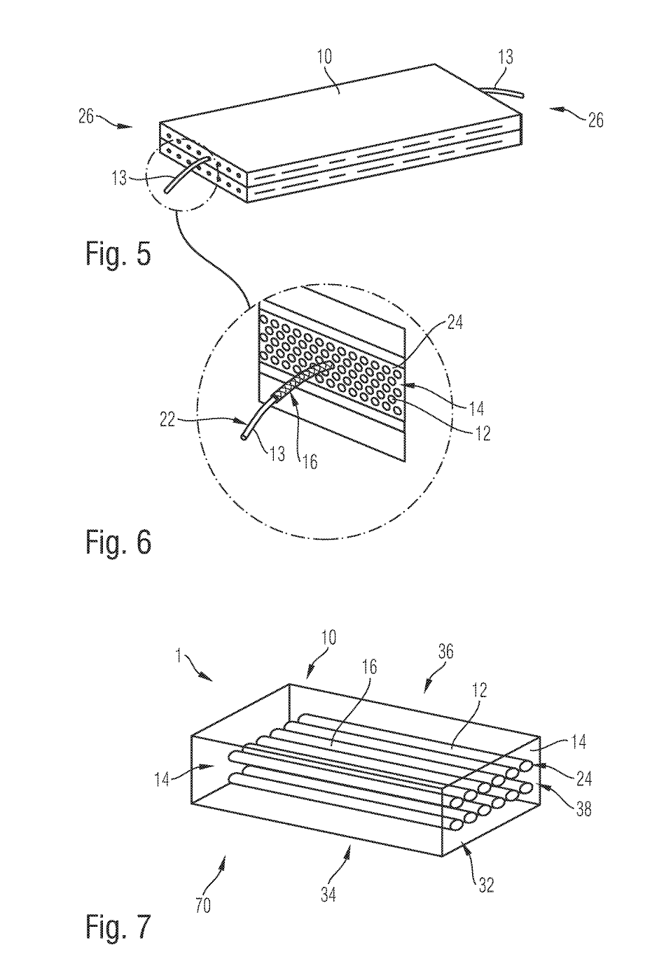

FIG. 6 shows the respective layer in greater detail. One can extract form FIG. 6 a single carbon fiber 13 and its coating 16 protruding from the flat short end 26 of its layer 24. At its end portion 18, the coating 16 of the carbon fiber 13 was stripped in order to establish a conductive connection with a signal or power source not shown in FIG. 6.

FIG. 7 exemplarily shows electrical power function capability provided by the composite laminate 10 forming a power source device 30 as a type of a composite battery as to obtain electrical power from the composite laminate. The basis for the structural component 1 according to the disclosure herein, again, is formed by a composite laminate 10, such as extractable form FIG. 7. In the figure is seen a perspective view of a section of such a composite laminate 10, built up of several layers (“plies”) of carbon fibers 12. The layers, again, are oriented in different directions and surrounded by polymer resin 14. At a lower portion of the composite laminate 10 one finds a metal layer 32 built by copper mesh forming a cathode 34, while at an upper portion of the composite laminate the carbon fibers 12 are disposed forming anodes 36. The cathode 34 and the anodes 36 are separated by an ion-transmissive separator, which is formed by a glass fiber layer 38. This arrangement may represent the first stage of a composite battery as a power source 30.

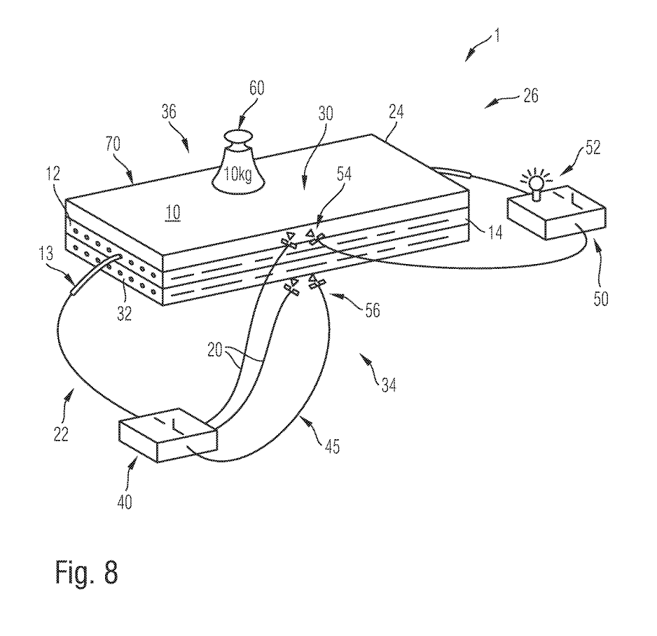

In FIG. 8 an exemplary embodiment of a structural element 1 is schematically illustrated, which shows the integrated functions of the composite laminate 10. One recognizes the same composite laminate 10 as in FIG. 6, now with the end portions 18 of the single carbon fiber 13 connected to an electric circuit 20 and a power source 30. At the left, one can see a signal sending device 40. With this signal sending device 40, signals transported along the single carbon fiber as a part of a signal circuit can be started and stopped. In order to electrically drive this device, it in itself has a power source 30. On the right hand side of the composite laminate 10, a signal receiving device 50 is seen, that registers when a signal is being sent. Again, this device needs a power source 30.

The electrical current needed for signals to flow in the cable formed by the carbon fibers 12 is obtained from the composite power source 30. This power source 30 is formed by the layer of carbon fibers 12 building anodes 36 together with the metal layer 32 building the cathode 34. Furthermore, the composite power source 30 provides power to the signal sending and receiving devices 40, 50, as well as to devices operated by their switching not shown here.

More specifically, most or all of the need for “power cables” disappear, when using the concept of composite power source 30. The reason is, that the composite power source 30 provides the power needed wherever the device is. Thus, no cable transmission losses will occur. Moreover, the only cable needed are the signal cables. But also for these applies that no separate signal cables will be necessary any more, since the built-in insulated carbon fibers 12 will serve this purpose.

One learns from FIG. 8, that one single carbon fiber 13 of the many carbon fibers 12 in the composite laminate 10 carries out an electrical transmission function while all the other fibers 12 carry out its superficial function, which is to carry a load, symbolically depicted as a weight 60. Accordingly the composite laminate 10 functions structurally and is loaded by a weight, placed in a central position in the middle of the laminate 10. Together with a metal layer 32 provided with the composite laminate 10, the coated carbon fibers 12 furthermore provide an independent composite power source 30 to drive the transmission carried out along a signal circuit 45 by the single carbon fiber 13.

To conclude, the disclosure herein provides a structural component 1 comprising a composite laminate 10 with at least one layer 24 containing carbon fibers 12 coated with ion-transmissive and electrically insulating coating 16. To establish a transmission a sending device 40 and a receiving device 50, for example running an identical protocol are provided as well as an arbitrary device with electrical function. The composite laminate 10 shows further features, such as cathode, so as to enable electrical energy storage to operate the sending and receiving devices in collaboration with the coated fibers 12 forming anodes 36.

To operate the corresponding devices, the sending device 40 is connected to a coated carbon fiber 13 intended as a data transmitter at an end portion 22 stripped of coating 16, the receiving device 50 is connected to the carbon fiber 13 in similar manner, the receiving device 50 is further connected to an output device 52, represented by a lamp in FIG. 8. Any or all signal cables and devices 13, 40, 50, 52, are connected, for integrated power, to positive and negative electrical connectors 54, 56 of electrical energy storing composite 70 which is formed by the power source 30 established by the composite laminate 10. Note, that different voltage may be used, either over a different number of cells, or with resistor built in circuit. After that, data may be sent from sending device 40.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the disclosure herein and its practical applications, to thereby enable others skilled in the art to best utilize the disclosure herein and various embodiments with various modifications as are suited to the particular use contemplated. In the appended claims and throughout the specification, the terms “including” and “in which” are used as the plain-English equivalents of the respective terms “comprising” and “wherein,” respectively.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A structural component comprising:
a composite laminate built up of a plurality of layers of carbon fibers, wherein the layers of carbon fibers are oriented in different directions, wherein the carbon fibers are surrounded by a conductive polymer resin, and wherein at least one layer of carbon fibers forms an anode;
a metal layer doped with an active cathode material forming a cathode;
an ion-transmissive, electrically insulating separator arranged between the anode and the cathode;
wherein the composite laminate forms a power source.

2. The structural component of claim 1, wherein the active cathode material is an electrolyte material.

3. The structural component of claim 2, wherein the active cathode material is a LiMn₂O₂ material.

4. The structural component of claim 2, wherein the active cathode material is a LiCoO₂ material.

5. The structural component of claim 2, wherein the active cathode material is a LiFePO₄ material.

6. The structural component of claim 1, wherein the ion-transmissive separator is a glass fiber layer arranged between the at least one carbon layer forming the anode and the metal layer.

7. The structural component of claim 1, wherein at least the carbon fibers of the at least one carbon layer forming the anode are set up with an ion-transmissive, electrically insulating coating forming the separator.

8. The structural component of claim 1, wherein the doped metal layer is set up by a metal mesh.

9. The structural component of claim 1, wherein a plurality of carbon fibers are provided for electrical transmission.

10. The structural component of claim 9, wherein the plurality of carbon fibers are provided for electrical signal transmission along the component.

11. The structural component of claim 1, wherein the at least one coated carbon fiber has a diameter between 3 and 12 micrometers, or between 5 and 10 micrometers.

12. The structural component of claim 11, wherein the at least one coated carbon fiber has a diameter between 5 and 10 micrometers.

13. The structural component of claim 1, wherein a composite laminate built up of a plurality of layers of carbon fibers forms a power source to drive electrical signals over at least one electrical connection formed by at least one coated carbon fiber extending through its layer between ends of the layer spaced apart from one another.

14. A structural component comprising:
a composite laminate built up of a plurality of layers of carbon fibers, wherein the layers of carbon fibers are oriented in different directions and wherein the carbon fibers are surrounded by a conductive polymer resin;
wherein the carbon fibers of at least one of the layers comprise an electrically insulating coating, and
wherein at least one of the coated carbon fibers extend through its respective layer to form an electrical connection between ends of the layer spaced apart from one another.

15. The structural component of claim 14, wherein stripped end portions of the at least one coated fiber protrude from its respective end of the layer and are connectable or connected with at least one of a transmission apparatus and its subset.

16. The structural component of claim 14, wherein the transmission apparatus is formed by at least one electrical circuit, which is connectable to at least one of a power source and a signal processing device.

17. The structural component of claim 14, wherein a plurality of carbon fibers are provided for electrical transmission.

18. The structural component of claim 17, wherein a plurality of carbon fibers are provided for electrical signal transmission along the component.

19. The structural component of claim 14, wherein the at least one coated carbon fiber has a diameter between 3 and 12 micrometers.

20. The structural component of claim 19, wherein the at least one coated carbon fiber has a diameter between 5 and 10 micrometers.

21. The structural component of claim 14, wherein a composite laminate built up of a plurality of layers of carbon fibers forms power source to drive electrical signals over at least one electrical connection formed by at least one coated carbon fiber extending through its layer between ends of the layer spaced apart from one another.

22. A method for providing a structural component, comprising:
providing a composite laminate of carbon fiber layers with at least one of which layers containing at least one carbon fiber coated with at least one of an electrically insulating coating and an ion-transmissive coating;
manufacturing the structural component;
stripping insulation at opposite ends of at least one coated carbon fiber;
connecting stripped ends of the at least one carbon fiber with at least one of a signal processor and a power source; and
transmitting/processing signals.

23. The method of claim 22, wherein the at least one coated carbon fiber is a carbon fiber yarn.

24. The method of claim 22, wherein the at least one coated carbon fiber is tow coated with an electrically insulating polymer electrolyte.

25. The method of claim 22, wherein a plurality of coated carbon fibers is used.

26. The method of claim 22, wherein the electrical signals processed are coded digital data signals.

27. An electrical wiring system extending along a structural component of an aircraft, wherein the electrical wires are formed by coated carbon fibers extending through at least one layer of a composite laminate of the structural component.

28. An aircraft comprising a structural component, the structural component comprising:
a composite laminate built up of a plurality of layers of carbon fibers, wherein the layers of carbon fibers are oriented in different directions, wherein the carbon fibers are surrounded by a conductive polymer resin, and wherein at least one layer of carbon fibers forms an anode;
a metal layer doped with an active cathode material forming a cathode; and
an ion-transmissive, electrically insulating separator arranged between the anode and the cathode;
wherein the composite laminate forms a power source.

29. An aircraft comprising a structural component, the structural component comprising:
a composite laminate built up of a plurality of layers of carbon fibers, wherein the layers of carbon fibers are oriented in different directions and wherein the carbon fibers are surrounded by a conductive polymer resin;
wherein the carbon fibers of at least one of the layers comprise an electrically insulating coating, and
wherein at least one of the coated carbon fibers extend through its respective layer to form an electrical connection between ends of the layer spaced apart from one another.
